(19) United States
(12) Patent Application Publication
(10) Pub. No.: US 2023/0318079 A1
(43) Pub. Date: Oct. 5, 2023

(54) Multi-Functional Thermo-Mechanical Cellular Structure for the Containment and Thermal Control of Heat Generating and Heat Absorbing Components

(71) Applicant: California Institute of Technology, Pasadena, CA (US)

(72) Inventors: Ratnakumar V. Bugga, Arcadia, CA (US); Scott N. Roberts, Altadena, CA (US); Benjamin I. Furst, Pasadena, CA (US)

(73) Assignee: California Institute of Technology, Pasadena, CA (US)

(21) Appl. No.: 18/295,090

(22) Filed: Apr. 3, 2023

Related U.S. Application Data
(60) Provisional application No. 63/326,439, filed on Apr. 1, 2022.

(51) Int. Cl. H01M 10/6552; H01M 10/656; H01M 10/643

(52) U.S. Cl. CPC H01M 10/6552; H01M 10/656; H01M 10/643; H01M 10/0525

(57) ABSTRACT

In some embodiments, a heat transfer device can include a case configured to receive at least one thermal element. The case can include an integrated oscillating heat pipe. The integrated oscillating heat pipe can be integrated into at least one wall of the case. The heat transfer device can further include a heatsink element. The heatsink element is in contact with at least one wall of the case. The integrated oscillating heat pipe can have two or more layers, and can extend in three dimensions.

### CROSS-REFERENCE TO RELATED APPLICATIONS

The current application claims the benefit of and priority under 35 U.S.C. § 119(e) to U.S. Provisional Patent Application No. 63/326,439 filed Apr. 1, 2022 entitled “Multi-Functional Thermo-Mechanical Cellular Structure for the Containment and Thermal Control of Heat Generating or Heat Absorbing Components”, the disclosure of which is hereby incorporated by reference its entirety for all purposes.

### STATEMENT OF FEDERAL FUNDING

This invention was made with government support under Grant No. 80NMO0018D0004 awarded by NASA (JPL). The government has certain rights in the invention.

### FIELD OF THE INVENTION

The present invention is generally related Battery systems. More particularly it is directed to high power battery systems capable of safe operation.

### BACKGROUND

The development of electric vehicles can be regarded as the next revolution in the transportation sector and multiple companies are actively developing electric vehicles. This transformation could be a critical step in the reduction of the nation's reliance on petroleum and for minimizing airborne pollution.

The high performance of modern Li-ion cells has been one of the enabling factors responsible for the recent renaissance in the development of electric vehicles. However, in order for electric vehicles to truly penetrate the marketplace and become widespread there are several obstacles that must be surmounted. Perhaps the most prominent issue facing Li-ion Batteries (LIB) is safety. The high specific energy and energy density of LIB's can make them inherently hazardous devices. The presence of a faulty cell in a battery, an internal short, or the unintentional abuse of the battery can lead to the thermal runaway of a cell. The subsequent propagation of heat to neighboring cells can trigger a cascading wave of thermal runaway events resulting in the catastrophic failure of an entire LIB. Thermal runaway of LIB's is a well-recognized phenomenon and is beginning to plague their usage in commercial applications, particularly with the increased energy content of modern cells. Numerous thermal runaway incidents in electric vehicles have been reported. A single <50 g high energy cell can release upwards of 80 kJ in a thermal runaway event. The explosive energy in ten such cells is equivalent to a standard stick of dynamite (190 g).

Several LIB designs have been proposed by various research groups to prevent the catastrophic failures due to thermal runaway. These designs typically focus on preventing the propagation of thermal runaway within a LIB, as the failure of a single cell cannot be completely precluded. A general technique is to prevent the heat generated from a reacting cell from being transmitted to neighboring cells, thereby avoiding the propagation of thermal runaway. This strategy can require the effective thermal insulation of each individual cell to prevent the transfer of heat between cells. State of the art designs utilizing this approach include incorporating intumescent materials around the cells to provide thermal isolation, using flexible polymeric pouches of water between the cells to absorb heat in the case of thermal runaway, encasing the cells in a phase change material (PCM) to absorb the heat, and inserting cells into a solid aluminum battery case with insulating sleeves to reduce the cell-to-cell heat transfer during thermal runaway. A major shortcoming of many designs is that they inhibit the capability of the LIB to sustain high power operation, as they substantially restrict the heat transfer from the cells. This can impact their usage in electric vehicle applications that require efficient cooling to sustain high power operation.

### SUMMARY OF THE INVENTION

In an embodiment, a heat transfer device includes a case configured to receive at least one thermal element. The case includes an integrated oscillating heat pipe. The integrated oscillating heat pipe is integrated into at least one wall of the case. The heat transfer device further includes a heatsink element. The heatsink element is in contact with at least one wall of the case.

In another embodiment, the heat transfer device has an effective thermal conductivity of around 900 W/m/K.

In a further embodiment, at least two thermal elements are spaced apart by the at least one wall.

In another further embodiment, at least two thermal elements are spaced apart by the at least one wall, and the wall is around 3 mm thick.

In yet another embodiment, the at least one thermal element is a lithium ion cell.

In a yet further embodiment, the at least one thermal element is cylindrical.

In another embodiment again, the at least one thermal element is prismatic.

In yet another embodiment again, the heat transfer device is manufactured as a single part using an additive manufacturing process.

In yet another further embodiment, there are sixteen thermal elements.

In yet another further embodiment again, there are ninety-six thermal elements.

In an additional embodiment, at least one received thermal element is a heatsink.

In another additional embodiment, at least one thermal element is a fluid.

In yet another additional embodiment, at least one wall includes various voids such that the weight of the heat transfer device is less than otherwise.

In an additional embodiment again, the integrated oscillating heat pipe comprises at least two or more layers.

In another additional embodiment again, the integrated oscillating heat pipe comprises at least two or more layers that are in fluid communication.

In yet another additional further embodiment, the integrated oscillating heat pipe comprises at least two or more layers, and wherein the topology of adjacent layers are generally rotated 90 degrees from each other.

In yet another additional further embodiment again, the case comprises a first integrated oscillating heat pipe and a second oscillating heat pipe.

In still another embodiment, the case comprises a first integrated oscillating heat pipe configured for maximum performance under a first set of thermal conditions and a second oscillating heat pipe configured for maximum performance under a second set of thermal conditions.

In still yet another embodiment, the case comprises a first integrated oscillating heat pipe with a first fill ratio corresponding to a first maximum performance under a first set of thermal conditions and a second oscillating heat pipe with a second fill ratio corresponding to a second maximum performance under a second set of thermal conditions.

In still another further embodiment, the case further comprises a first portion with a first integrated oscillating heat pipe, and a second portion with a second integrated oscillating heat pipe, and wherein the first portion and the second portion are both in contact with both of at least two thermal elements received by the case.

In still another embodiment again, the case further comprises a second integrated oscillating heat pipe, and wherein the first oscillating heat pipe is integrated in a first region of the at least one wall, and wherein the second oscillating heat pipe is integrated in a second region of the at least one wall.

In a still yet further embodiment, the case further comprises a first portion with a first integrated oscillating heat pipe, and a second portion with a second integrated oscillating heat pipe, and wherein each thermal element of the at least one thermal element is in contact with at most integrated oscillating heat pipe selected from among the first and the second integrated oscillating heat pipe.

In still another yet further embodiment, the heatsink element is positioned to be in contact with the case and all of the at least one thermal elements.

In still another additional embodiment, at least two heatsink elements are disposed within the at least one wall of the case.

In still another additional embodiment again, the case further comprises a first portion with a first integrated oscillating heat pipe, a second portion with a second integrated oscillating heat pipe, and a third portion that is a heatsink, and wherein the first portion, the second portion, and the third portion are both in contact with both of at least two thermal elements received by the case.

In yet still another additional embodiment again, the case further comprises a first portion with a first integrated oscillating heat pipe, a second portion with a second integrated oscillating heat pipe, and a third portion that is a heatsink, and wherein the first portion, is arranged on a first side of the third portion, and the second portion is arranged on a second side of the third portion.

In yet still another further additional embodiment, the case if further configured to receive that at least one thermal element into a receiver, and wherein the receiver is further configured to receive a heatsink element.

In yet still another further additional embodiment again, the case comprises a first integrated oscillating heat pipe tunable to a first thermal setting and a second oscillating heat pipe tunable to a second set of thermal conditions, the second set of thermal conditions.

In still yet another embodiment, the case comprises a first integrated oscillating heat pipe with a first fill ratio, a second oscillating heat pipe with a second fill ratio, the second fill ratio different from the first fill ratio.

In still yet another embodiment again, the case comprises a first integrated oscillating heat pipe with a first working fluid, and a second oscillating heat pipe with a second working fluid, the second working fluid different from the first working fluid.

In an embodiment, the battery case includes a case configured to receive at least one cell. The case includes an integrated oscillating heat pipe. The integrated oscillating heat pipe is integrated into at least one wall of the case. The case further being coupled to a heatsink element. wherein the heatsink element is in contact with at least one wall of the case.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 conceptually illustrates a performance comparison comparing an AM OHP LIB case to currently available state of the art LIBs.

FIGS. 2A and 2B conceptually illustrate an example of an AM LIB case with an embedded OHP.

FIG. 3 conceptually illustrates a summary of some example previous systems for comparison with an example AM OHP LIB.

FIG. 4 conceptually illustrates a cutaway image of an AM battery case that integrates conformal OHP directly within its structure.

FIG. 5 depicts specifications for an example 96 cell (1.2 kWh) LIB design that utilizes an AM LIB case with embedded OHPs.

FIG. 6 conceptually illustrates an example AM OHP LIB and a corresponding OHP.

FIG. 7 conceptually illustrates an example of test data from an AM OHP LIB.

FIGS. 8A and 8B conceptually illustrate two different planes of an OHP AM battery case in cross-section.

FIG. 9 depicts results from an exemplary study indicating OHP performance.

FIG. 10 conceptually illustrates a steady state simulation of an example 16-cell case during high power operation.

FIG. 11 conceptually illustrates an example battery case showing walls with reduced mass.

FIG. 12 illustrates an example AM OHP LIB battery case.

FIGS. 13A and 13B depict X-rays of an example 96-cell AM OHP LIB case.

FIGS. 14A through 14D conceptually depict an example of a 96-cell AM OHP heat transfer device.

FIG. 15 conceptually illustrates an example temperature distribution for an example AM OHP LIB case with 96 cells.

FIGS. 16A through 16D conceptually illustrate an example AM OHP battery case for prismatic and/or pouch cells.

FIGS. 17A through 17B conceptually illustrate two views of a first configuration of an OHP enabled heat transfer system.

FIGS. 18A through 18B conceptually illustrate two views of a second configuration of an OHP enabled heat transfer system.

FIGS. 19A through 19B conceptually illustrate two views of a third configuration of an OHP enabled heat transfer system.

FIGS. 20A through 20B conceptually illustrate two views of a fourth configuration of an OHP enabled heat transfer system.

FIGS. 21A through 21B conceptually illustrate two views of a fifth configuration of an OHP enabled heat transfer system.

FIGS. 22A through 22B conceptually illustrate two views of a first configuration of an OHP enabled heat transfer system with heat sinks.

FIGS. 23A through 23B conceptually illustrate two views of a second configuration of an OHP enabled heat transfer system with heat sinks.

FIGS. 24A through 24B conceptually illustrate two views of a third configuration of an OHP enabled heat transfer system with heat sinks.

FIGS. 25A through 25B conceptually illustrate two views of a fourth configuration of an OHP enabled heat transfer system with heat sinks.

FIGS. 26A through 26B conceptually illustrate two views of a fifth configuration of an OHP enabled heat transfer system with heat sinks.

FIGS. 27A through 27B conceptually illustrate two views of a sixth configuration of an OHP enabled heat transfer system with heat sinks.

FIGS. 28A through 28B conceptually illustrate two views of a seventh configuration of an OHP enabled heat transfer system with heat sinks.

FIGS. 29A through 29B conceptually illustrate two views of an eighth configuration of an OHP enabled heat transfer system with heat sinks.

### DETAILED DESCRIPTION

Safe, high-powered Li-ion Batteries (LIB) can enable a reliable electrification of the US transportation system. Widespread adoption of electrified transportation systems can require safe, high-power Li-ion batteries.

The high specific power and high specific energy of Li-ion cells coupled with their low cost makes them an energy storage solution for electric vehicles (e.g., automobiles, aircraft, and/or other vehicles). There are at least two significant thermal engineering challenges that should be addressed for the successful implementation of Li-ion batteries in electric vehicles: providing adequate cooling during high power operation, and inhibiting catastrophic failure associated with propagation of thermal runaway. In several embodiments, a thermal control system can provide adequate cooling of a battery during high power operation (charging/discharging). In accordance with various embodiments of the invention, a thermal control system can be capable of inhibiting the catastrophic failure associated with the propagation of thermal runaway. The importance of battery safety is paramount to facilitate the widespread adoption of electric vehicles. This has been underscored by the multiple Li-ion battery fires that have plagued electric automobiles, aircraft and consumer electronics in recent years.

Li-ion batteries, in some embodiments, address the aforementioned thermal challenges by utilizing a novel Additively Manufactured (AM) battery case that incorporates conformal Oscillating Heat Pipes (OHP). Such a thermal control system can be lightweight, and/or can have the capability to provide cooling during high power operation as well as inhibit the propagation of thermal runaway. In many embodiments, a safe, modular, high-power Li-ion battery can enable the next generation of safe, high-performance electric vehicles.

An apparent incompatibility of safety and high-power operation for LIB's stems from the common preconception that in order to inhibit the propagation of thermal runaway, the cells must be thermally insulated. However, in several embodiments, an AM LIB case (e.g., a battery case) with embedded passive thermal control features can be able to diffuse a thermal runway event as well as efficiently transport the heat generated during high power operation. A principal characteristic of some battery cases can be a highly enhanced thermal conductance. Unlike traditional methods of ensuring LIB safety which rely on thermally insulating the cells, in various embodiments, a battery case is configured for enhanced thermal conductance of the case to rapidly and evenly distribute heat emitted during a thermal runaway event throughout the entire LIB. The result can be that during a single cell thermal runaway event, the entire LIB undergoes a modest temperature rise as it absorbs the energy release as sensible heat. This can prevent a damage to the other cells in the battery. The high thermal conductance of the case can also enable efficient heat transport to an external heatsink during high power operation of the LIB.

Typically, in an array of heat generating components such as a Li-ion battery, there is the danger that a single cell will undergo a thermal runaway type failure and release large amounts of energy in the form of heat. If no precautions are taken, this release of heat can trigger the propagation of thermal runaway throughout the entire system by the subsequent overheating of adjacent cells. A common method of preventing this type of failure is to thermally insulate the cells from one another. In contrast, in some embodiments, the thermal system utilizes a heat transfer approach to diffuse the propagation of thermal runaway that goes against common knowledge. Instead of inserting thermally insulating materials between the cells, in several embodiments a battery case includes providing thermally conductive material between the cells in order to prevent thermal runaway. In an additively manufactured oscillating heat pipe Li ion battery (AM OHP LIB) this thermally conductive material can be a mechanical structure of the case with an embedded OHP. With this configuration the heat released from a cell during thermal runaway is rapidly distributed throughout the entire case. This is beneficial to prevent the heat being focused on the cells adjacent the reacting cell. The result is that the entire case undergoes a modest increase in temperature that is within the safe operating limits of the battery.

In various embodiment of the invention, advantages of using AM to manufacture an OHP heat transfer device (e.g., an AM OHP LIB case) can include (1) structural optimizations resulting in complex geometries are easily buildable. Further, in some embodiments, LIBs can be integrated with other structures to further expand its multi-functional nature. In some embodiments, a battery case can be integrated with a liquid-cooled cold plate that can be used to draw heat away from an LIB. This arrangement can provide both mass and performance enhancements as critical mechanical and thermal interfaces are removed. This arrangement can also be integrated with other advanced thermal management systems, such as low-offset MLI to minimize incident radiation from the environment, thermal switches for thermally isolating the battery case, and/or conformal geometries where volume and packing are more important than mass.

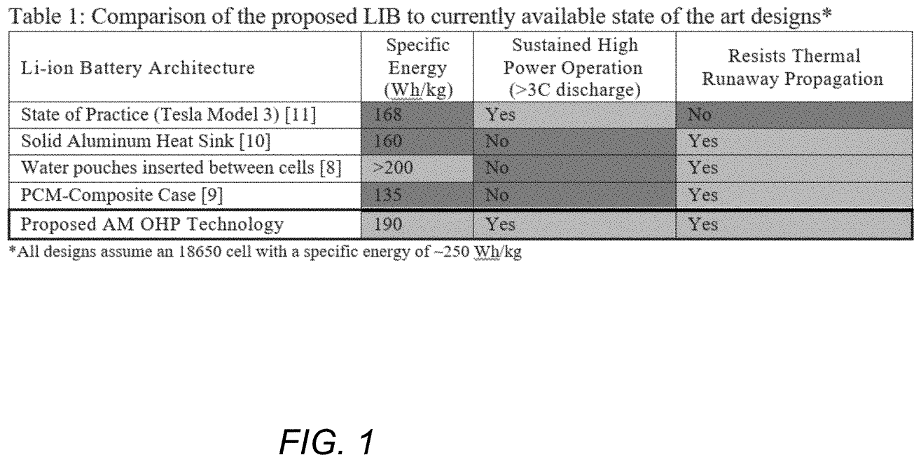

A performance comparison comparing an AM OHP LIB case to currently available state of the art LIBs is conceptually illustrated in FIG.1. The AM OHP LIB provide a safe, high power operation in a lightweight package. This technology can enable the widespread adoption of electric vehicles.

In various embodiments, the OHP LIB can be an Additively Manufactured (AM) battery case that integrates three-dimensional conformal Oscillating Heat Pipes (OHP) directly within its structure to provide thermal control. An OHP can be a passive, two-phase thermal control device that utilizes boiling and condensation to rapidly, and efficiently, transport heat. By embedding an OHP directly into the battery case, the effective thermal conductivity of the structure can be increased by an order of magnitude or more, enabling it to accommodate thermal runaway and high-power operation.

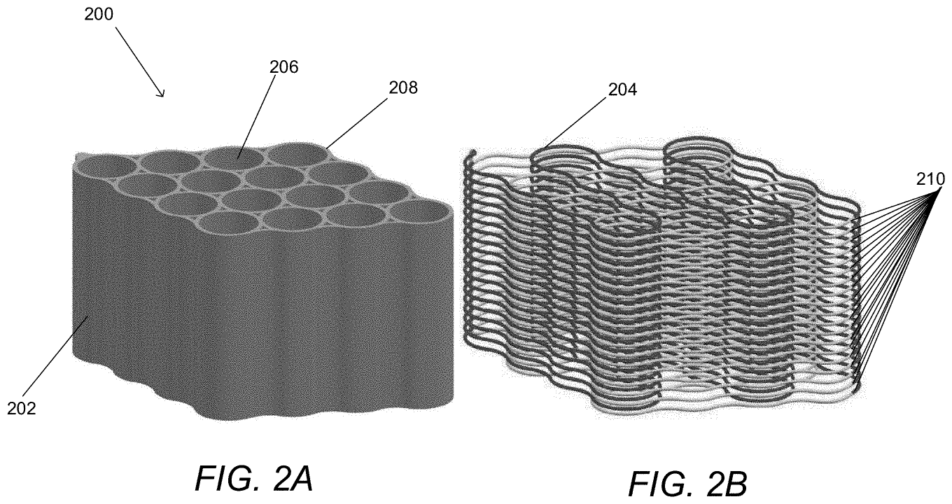

An example of an AM LIB case with an embedded OHP is conceptually illustrated in FIGS. 2A and 2B. In several embodiments, a three-dimensional conformal OHP can be embedded in an AM LIB case.

An AM OHP LIB case 200 can be formed of a structure 202 with embedded OHP 204. The OHP 204 can be formed within the structure 202 (e.g., during an AM process). The case 200 can have cell holders 206. The case 200 depicted in FIG. 2A and 2B has 16 cell holders, but an AM OHP LIB case could have any number of cell holders. Cell holders can be configured to receive Li-ion cells. The OHP 204 can include tubes formed as open spaces within the walls 208 of the structure 202. The OHP 204 is a three-dimensional OHP. The OHP 204 can include OHP layers 210. In various embodiments, the OHPs can be arranged such that alternating layers run generally perpendicular to each other. In several embodiments the alternating layers can be in fluid communication.

The battery case 200 can be configured to accommodate a number of the standard 18650 Li-ion cells. A similar case could be used for a variety of types of cell. A conformal OHP (e.g., OHP 204) is integrated into the walls of the structure 202. The battery case 200 enables high power charge and discharge of a Li-ion battery by efficiently removing heat from the cells during operation. It also has the capability to prevent the propagation of thermal runaway, by rapidly diffusing the heat evolved from a failing cell and distributing the heat amongst the remainder of the battery. These concepts are further discussed elsewhere herein. The structure 202 shown in FIG. 2A has the OHP 305 shown in FIG. 2B embedded within its walls.

In several embodiments an apparatus provides for the thermal control and/or mechanical containment of an array of heat generating or heat absorbing components. The apparatus can include a physical case that can accommodate an array of heat generating and/or heat absorbing components. The apparatus can contain an Oscillating Heat Pipe (OHP). The OHP can be embedded directly into the structure. The embedded OHP can be configured in the case in such a way as to transport heat from the heat generating components to the heat absorbing components and/or to an external heatsink. The OHP can be arranged in multiple different topologies to gain a wide range of thermal effects and transport efficiencies.

AM OHP LIB cases can offer various features including: (1) the ability to rapidly and efficiently transport heat from an array of heat generating components (e.g., Li-ion cells) to an external heatsink, (2) the ability to rapidly and efficiently transport heat from a single (or group) of components that are generating heat to the remainder of the case or to an external heatsink (e.g., to mitigate a cell failure), and/or (3) the ability to isothermalize the array of heat generating or heat absorbing components.

In various embodiments, AM OHP LIB cases can be used to accommodate any cellular array of heat generating and/or heat absorbing components that can benefit from thermal control. This includes at least Li-ion batteries, fuel cells, nuclear reactors electronics, computers, and other systems.

In several embodiments, the structure of a battery case can be a cellular structure. Several embodiments include a complex OHP integrated into a cellular structure for thermal control. In accordance with various embodiments of the invention, an integrated OHP can be a three-dimensional OHP with a complex topology that deviates from the typical meandering layout is novel.

Typical component level passive two-phase thermal control devices such as a heat pipe, loop heat pipes, and/or oscillating heat pipes are designed and configured to accommodate a single heat load. Occasionally these devices can be used to accommodate a few heat loads when the arrangement is convenient. When these devices are configured to thermally control an array of elements, multiple individual heat pipe units can be assembled into a larger system in order to provide adequate thermal control.

Li-ion batteries (LIB) are common in modern power systems. The high specific energy of Li-ion cells coupled with their stable cycling performance makes them the ideal candidate for the energy storage needs of most missions. A common industrial format is the cylindrical 18650 cell, and it is often a geometry of choice when implementing new chemistries in the commercial sector. Some commercially available advanced 18650 cells can have specific energies as high as 250 Wh/kg, compared to specific energies of 160 Wh/kg to 180 Wh/kg for custom prismatic cells with heritage chemistries.

There are at least three primary issues with current Li-ion batteries (LIB): First, susceptibility to the propagation of thermal runaway. Second, limited to low discharge rates. Third, relatively massive and therefore considerably reduce the specific energy from the cell level. These outstanding issues are generally acknowledged in the industry, and multiple groups are attempting to address them with different approaches.

### Thermal Runaway

The high specific energy of Li-ion batteries combined with their energetic chemistry can make them hazardous devices. The presence of a faulty cell in a battery, an internal short, or the unintentional abuse of the battery can lead to thermal runaway of a cell. The subsequent propagation of heat to neighboring cells can trigger a cascading wave of thermal runaway events resulting in the catastrophic failure of at least the entire LIB. Thermal runaway of LIBs is a common phenomenon beginning to plague usage of LIBs in both terrestrial and space applications, particularly with the increased energy content of modern cells.

### High Power Operation

Recent COTS 18650 LIBs can have the capability to support high charge and discharge rates when equipped with adequate thermal control. For example, the maximum specified discharge rate for the high specific energy LG-MJ1 cell is 10 A, corresponding to a 2.8 C-rate. However, at this high discharge rate the cell produces 4 W of heat, requiring thermal control typically available only at the cell level in a laboratory setting. State of the practice LIBs are designed to support discharge rates of 0.5 C. This limitation can often be primarily due to the insufficient thermal control inherent in typical LIB systems, as they are unable to adequately manage the heat generated at higher discharge rates.

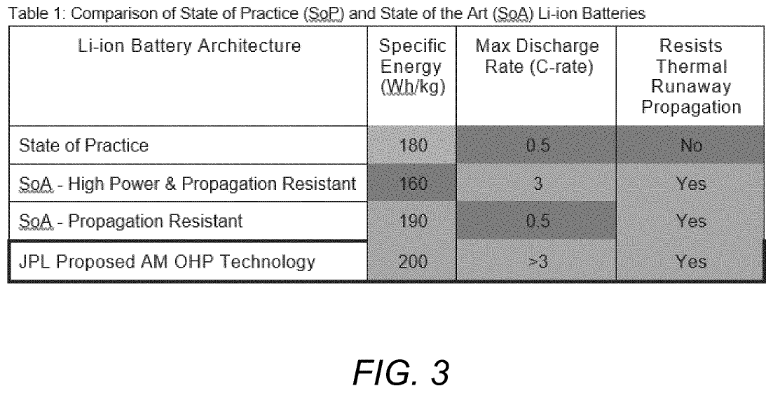

A summary of some example previous systems for comparison with an example AM OHP LIB are given in FIG. 3.

In various embodiments, a next generation Li-ion battery (LIB) is described that surpasses the current state of the art designs in specific energy and high power capability while maintaining resistance to the propagation of thermal runaway. In accordance with embodiments of the invention, this enhanced performance can be because of an Additively Manufactured (AM) battery case that integrates conformal Oscillating Heat Pipes (OHP) directly within its structure.

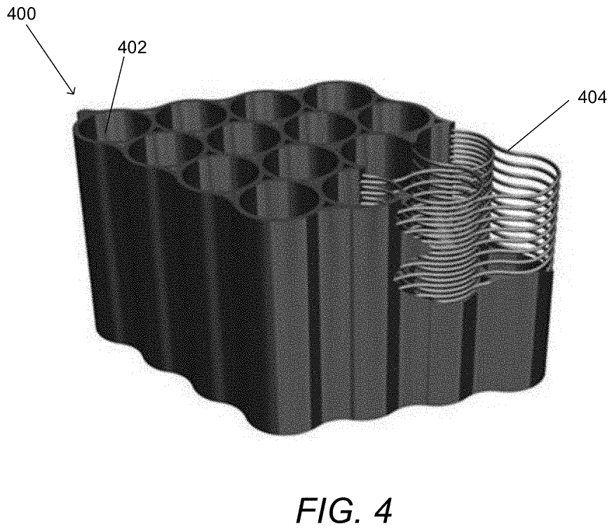

A cutaway image of an AM battery case that integrates conformal OHP directly within its structure is conceptually illustrated in FIG. 4. A Li-ion battery (LIB) case 400 can be configured to receive cells. The case 400 can include 16 cell receivers 402. The case 400 can include an embedded Oscillating Heat Pipe (OHP) 404. By embedding the OHP directly into the structure, the effective thermal conductivity of the battery case can be increased by over an order of magnitude, enabling high power performance and propagation resistance in a conformal package. This design can be enabled by Additive Manufacturing (AM) techniques used for manufacturing an AM OHP LIB. An Oscillating Heat Pipe can be a passive, two-phase thermal control device that utilizes boiling and condensation to rapidly, and efficiently, transport heat.

A Cutaway illustration of an AM 16 cell Li-ion battery case with an embedded OHP is conceptually illustrated in FIG. 4. In accordance with embodiments of the invention, a battery case can provide functions including: (1) During high power operation, heat is rapidly removed from the operational cells and transported into a secondary heatsink, cold plate, and/or radiator; and/or (2) During a thermal runaway event, the heat released from a reacting cell is rapidly distributed throughout the entire LIB (e.g., by the battery case), where it is absorbed as sensible heat, resulting in a modest temperature rise (e.g., a modest temperature rise across the whole LIB).

In several embodiments the battery case performance can be enabled by the implementation of a highly non-traditional three-dimensional OHP topology. The topology can be conformal to cell holders of an OHP battery case. The optimization and fabrication of this OHP design can require both the capability to fabricate the OHP as well as the capability to analyze the OHP.

Battery cases, in many embodiments, with embedded high performance OHP devices can require use of AM Powder Bed Fusion systems.

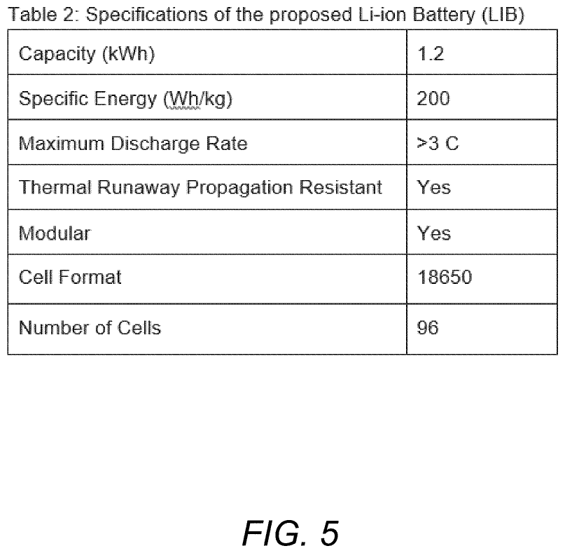

Specifications for an example 96 cell (1.2 kWh) LIB design that utilizes an AM LIB case with embedded OHPs are given in FIG. 5. In various embodiments, using an AM OHP battery case can allow a LIB to support a 3 C discharge rate while simultaneously providing for prevention of propagation of thermal runaway while maintaining a specific energy of 200 Wh/kg with a 250 Wh/kg commercially available cell. In several embodiments an AM OHP battery case can be made from aluminum. For some embodiments, an x-ray CT scan can be used to verify that the internal geometry of an AM OHP LIB case is correctly built.

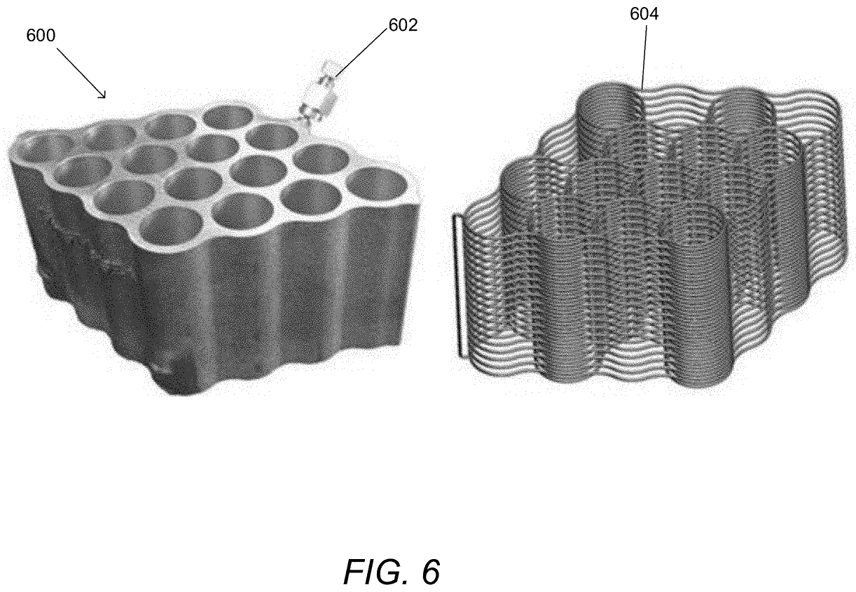

An example AM OHP LIB and a corresponding OHP are conceptually illustrated in FIGS. 6A-B. The AM OHP battery case 600 can include a charging port 602. The charging port 602 can be in fluid communication with the OHP 604. In many embodiments, the OHP can have a convoluted design that substantially departs from traditional, planar OHPs. The OHP 604 be incorporated as a single piece with the battery case 600. In some embodiments, an OHP can be formed of interior passages within the battery case. The battery case with integrated OHP passages can be produced with AM from a single material. The passages can be interconnected voids within a battery case's walls.

For various embodiments, operational verification of the OHPs was done through thermal testing using heaters to emulate battery heat loads. Measured heat load and temperature data were used to determine the effective thermal conductivity of the battery case and OHP channels. In accordance with some embodiments of the invention, thermal conductivities of the OHP channels can be around 3,400 W/m/K, and/or effective thermal conductivities of the battery case can be around 900 W/m/K. For some embodiments, an OHP battery case can be a 16-cell battery case. Cell-to-cell spacing can, in various embodiments, be of around 3 mm, around 2 mm, and/or another spacing distance. In several embodiments, a specific energy of an AM OHP LIB can be around 190 Wh/kg and/or around 200 Wh/kg.

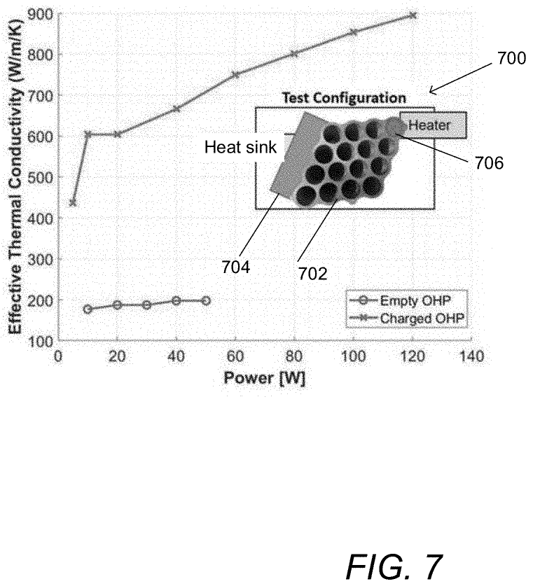

In several embodiments, a battery case can be manufactured in aluminum. The aluminum can have embedded heat pipes. The heat pipes can be suitable for use as heat pipes for an OHP. An example of test data from an AM OHP LIB is conceptually illustrated in FIG. 7. The test configuration 700 includes an AM OHP LIB 702 with 16 cells. The test configuration 700 can further include a heatsink 704 coupled to a first side of the AM OHP LIB 702. A heater cell 706 can be arranged in a position opposite the heatsink 704.

As depicted in FIG. 7, thermal testing can be used to verify OHP operation. In an example test, a 16-cell battery case OHP was confirmed to operate via a thermal test where heat was applied to a single cell (e.g., heater cell 706), while the opposite battery case boundary was connected to a heatsink (e.g., heatsink 704). For several embodiments, testing verified that the non-traditional OHP geometry operated, with effective conductivities of the case reaching values up to 900 W/m/K (greater than four times the empty aluminum case).

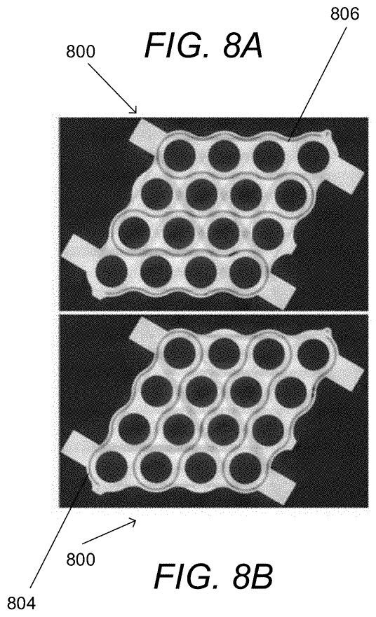

Two different planes of an OHP AM battery case in cross-section are depicted in FIGS. 8A and 8B. FIG. 8A depicts a first cross-section of an OHP AM battery case 800. The OHP section 802 runs generally laterally in the layer shown in the first cross section. FIG. 8B depicts a second cross-section of an OHP AM battery case 800. The OHP section 804 runs generally longitudinally on the layer shown in the second cross section. The OHP section 802 shown on the first cross-section, and the OHP section 804 shown on the second cross-section can be generally perpendicular. In several embodiments, an OHP can have alternating layers of OHP sections. The alternating layers of OHP sections can be generally perpendicular to each other.

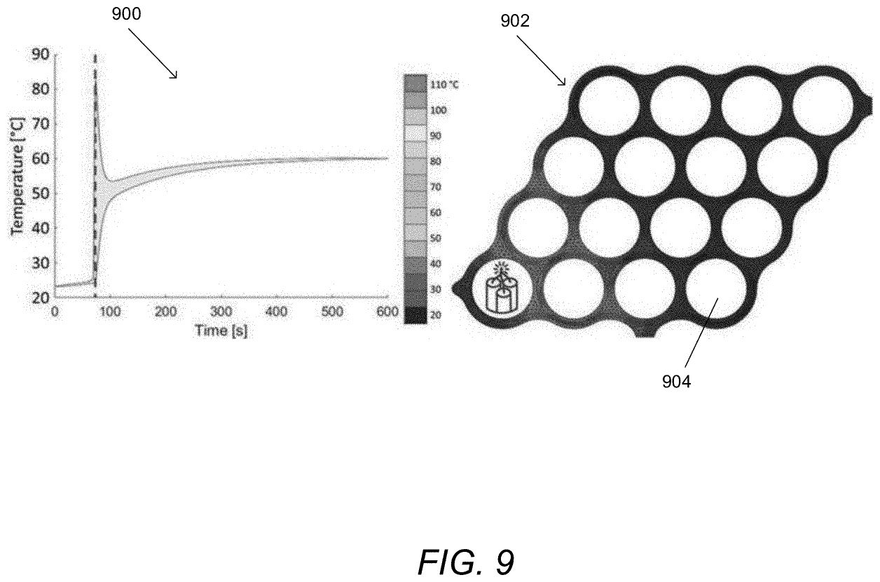

An exemplary study indicating OHP performance is conceptually illustrated in FIG. 9. FIG. 9 includes a chart 900 of temperature against time, and an OHP LIB 902. In some embodiments, OHP performance can be improved by another factor of five (e.g., a factor of 5 beyond the levels indicated in connection with FIG. 7), and/or can operate in a more consistent regime with additional optimization.

In accordance with several embodiments of the invention, in addition to a basic test campaign confirming the operation of the conformal battery case OHP, extensive modelling has been done to explore the performance of the device during thermal runaway and high-power operation. For example, a 2D numerical model of the 16-cell battery case with embedded OHPs was developed, verified, and/or correlated with test results. For some embodiments, parametric studies were conducted with the model to explore the effect of different OHP channel thermal conductivities as well as effects of thermal interface conductances between the cells and case(e.g., cells 904, and case 902). For several embodiments, it was found that even for mediocre OHP performance (e.g., structural effective thermal conductivities of around 2,600 W/m/K) and a wide range of thermal interface conductances between the cells and the case, the design is able to suppress the propagation of thermal runaway and support high power operation. FIG. 9 shows a transient 2D simulation of a thermal runaway event with a 16-cell case (e.g., as shown in FIG. 2A-B. In several embodiments, even for a small system (e.g., a 16-cell case), the thermal performance can be such that cells adjacent to the reacting cell see a maximum temperature rise of 50° C. and/or see a temperature rise while remaining within safe operational temperature limits. In some embodiments with a 96-cell case, the thermal performance can be such that the temperature rise of the entire case will not exceed 10° C., due to the additional thermal mass that is present.

Simulation results from a thermal runaway event in the lower left corner cell of a case 902 are shown in chart 900. In a test, this can represents a challenging thermal scenario. In several embodiments, in the test, the range of temperatures in the case seen by the remaining healthy cells during the thermal runaway event. For an initial temperature of 23° C., the healthy cells adjacent to the reacting cell can, in some cases, see a maximum temperature of 83° C. during the thermal runaway event. Assuming no external heatsink, the entire LIB case can increases by about 40° C. as it absorbs the heat from the reacting cell. The chart 900 is a contour plot that shows the temperatures of a case (e.g., case 902) immediately after peak heat release, signified by the vertical dashed line on the adjacent plot. This 2D transient numerical model assumes a mediocre OHP performance (10,000 W/m/K at the channel level), corresponding to a structural effective conductivity of 2,600 W/m/K. In some embodiments an OHP can have a thermal performance corresponding to 10,000 W/m/K at the channel level. In several embodiments, an OHP battery case can have a structural effective conductivity of 2,600 W/m/K.

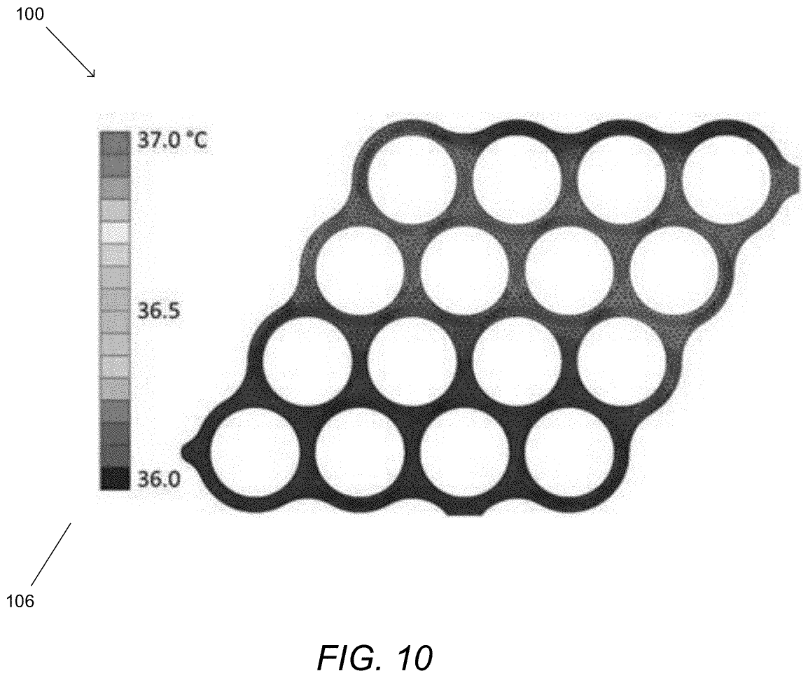

A steady state simulation of an example 16-cell case during high power operation is shown in FIG. 10. The simulation can correspond to a 3 C discharge rate, where each cell dissipates 5 W and the battery case is connected to a constant temperature heatsink at the upper boundary. In the depicted simulation, the temperature gradient across the case is less than 1° C. indicating the case's ability to handle higher discharging rates (e.g., when each cell can be outputting greater than 5 W of waste heat).

FIG. 10 shows a steady state, 2D simulation of a 16-cell case under high power operation. In the simulation, each cell is assumed to dissipate 5 W, corresponding to a 3 C discharge rate. A side of the battery case is assumed to be in contact with an isothermal heatsink at 20° C. The remainder of the boundaries are adiabatic. The maximum temperature gradient across the case is less than 1° C. The temperature difference of 17° C. between the isothermal heatsink and the battery case are due to a modelled thermal interface resistance. In various embodiments, the case can have an effective thermal conductivity of 2,600 W/m/K.

An example battery case showing walls with reduced mass is conceptually illustrated in FIG. 11. A battery case 1100 can be configured to receive a cell 1102 into a receiver 1104. The walls 1106 of the battery case 1100 can have removed material to form holes 1108. In several embodiments, material can be removed from in between the OHP channels to reduce the mass of the case. OHP channels can be integrated within the volume of the battery case walls. In various embodiments, mass can be reduced by reducing wall thicknesses and removing other unnecessary interstitial mass.

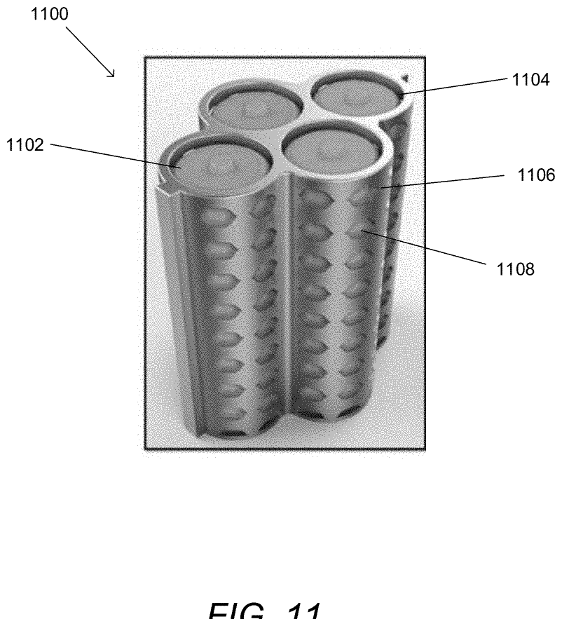

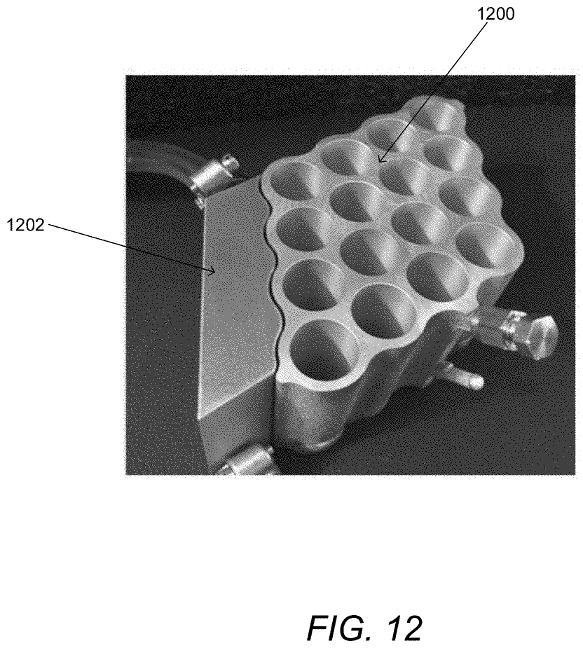

An example AM OHP LIB battery case is conceptually illustrated in FIG. 12. A battery case 1200 can be coupled to a heatsink (e.g., cold plate) 1202. In some embodiments, the heatsink and the battery case could be a single part.

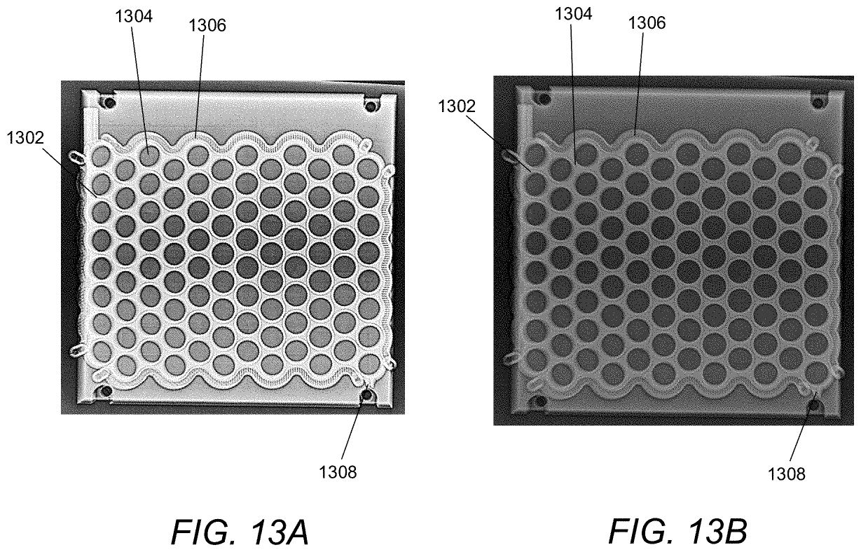

X-rays of an example 96-cell AM OHP LIB case is shown in FIGS. 13A-B. OHP channels 1302 can be seen between the cells 1304. The outer perimeter of the case can include a heatsink 1306. Heatsinks, in various embodiments can be additively manufactured as a single piece with a battery case. The case can further include an inlet 1308 through which the OHP channels 1302 can be charged. In various embodiments, an AM OHP LIB case can incorporate at least two OHP systems. The at least two OHP systems can be configured to have optimal performance under different thermal conditions in accordance with embodiments of the invention.

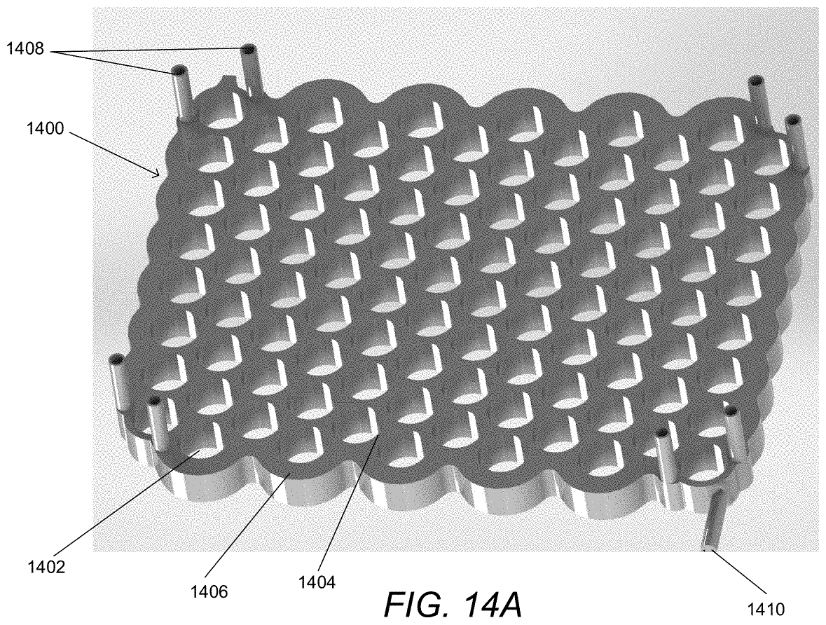

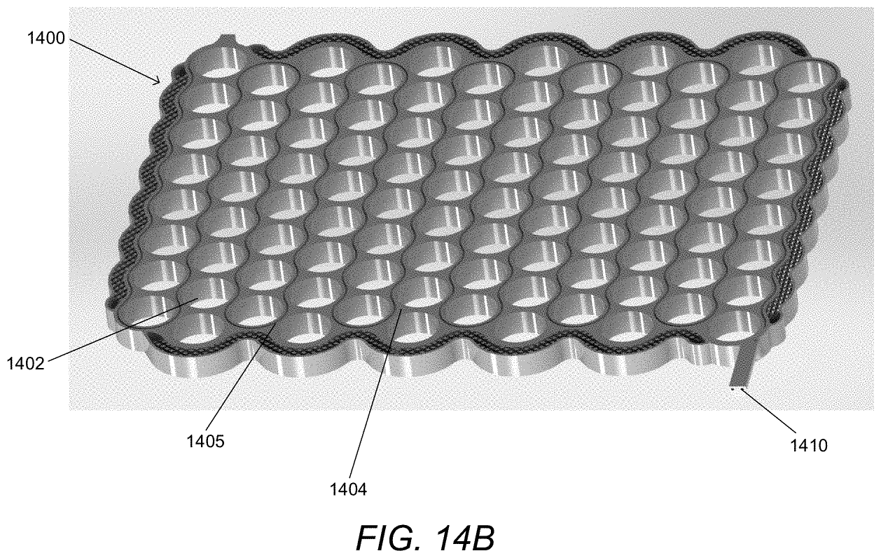

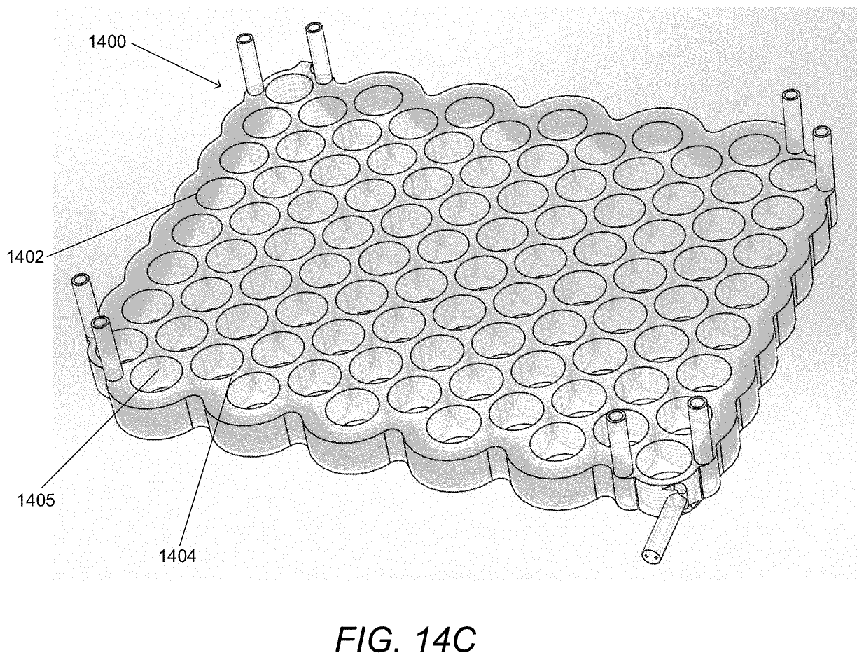

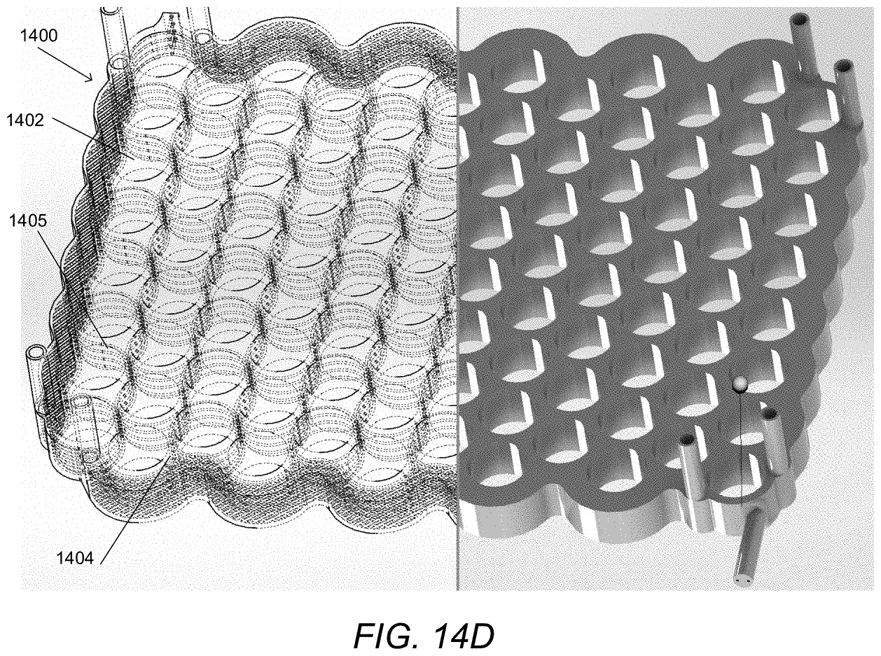

An example of a 96-cell AM OHP heat transfer device is conceptually illustrated in FIGS. 14A-E. FIG. 14B is a cross-section of the device. A 96-cell AM OHP heat transfer device can be configured to receive Lithium Ion cells. An AM OHP heat transfer device 1400 can include cells 1402. The cells 1402 can be arranged with walls 1404 separating the cells 1402. The walls 1404 can have integrated heat pipes 1405. The heat pipes can be manufactured as part of the walls 1404. Integrated heat pipes can include layers. Each layer can span across some or all of the cells 1402. In several embodiments, some of the layers of the OHP can each extend in a longitudinal and transverse direction. Layers of the OHP can be offset from one another along an axis generally perpendicular to the longitudinal and transverse directions. In many embodiments, the layers of the OHP can be in fluid communication thereby forming an OHP with a three-dimensional topology.

In several embodiments, a heatsink 1406 can be manufactured as a single component with the heat transfer device 1400 (e.g., using an AM process). In several embodiments, heatsinks can be arranged around the perimeter of the heat transfer device. As discussed elsewhere herein, many configurations can be used for an AM OHP heat transfer device. In the depicted example, the heat transfer device 1400 is configured for receiving cylindrical cells to form a LIB. However, AM OHP heat transfer devices can be configured for receiving prismatic cells, pouch cells, process fluids, and/or other thermal elements. The heat transfer device 1400 can include mechanical connection components 1408. The heat transfer device 1400 can include ports 1410. The ports 1410 can be in fluid communication with an integrated OHP filling the OHP. In several embodiments, the OHP follows an undulating path to conform to the walls 1404. In various embodiments, the type of heatsink can be any type of heatsink. The walls of the battery case, in some embodiments form a honeycomb-like structure. The spaces within the honeycomb-like structure can be configured to receive cells (e.g., Li ion cells).

An example temperature distribution for an example AM OHP LIB case with 96 cells is conceptually illustrated in FIG. 15. The example temperature distribution shown on the left corresponds to a test for a thermal system consisting of just an aluminum battery case. The example temperature distribution on the right corresponds to a test for a thermal system consisting of an AM OHP LIB case as described throughout this document. The conditions to which the battery cases are subjected are the same on the right and the left sides. For both tests, a heat source is provided on the left side, and a heatsink is provided on the right side.

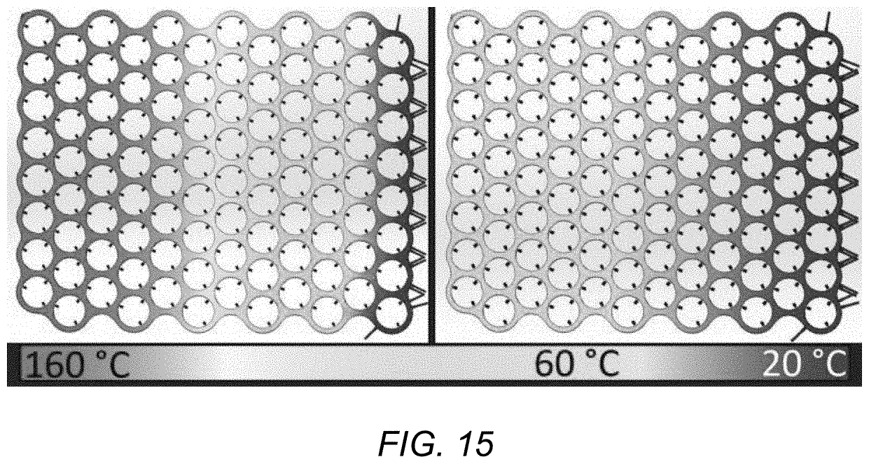

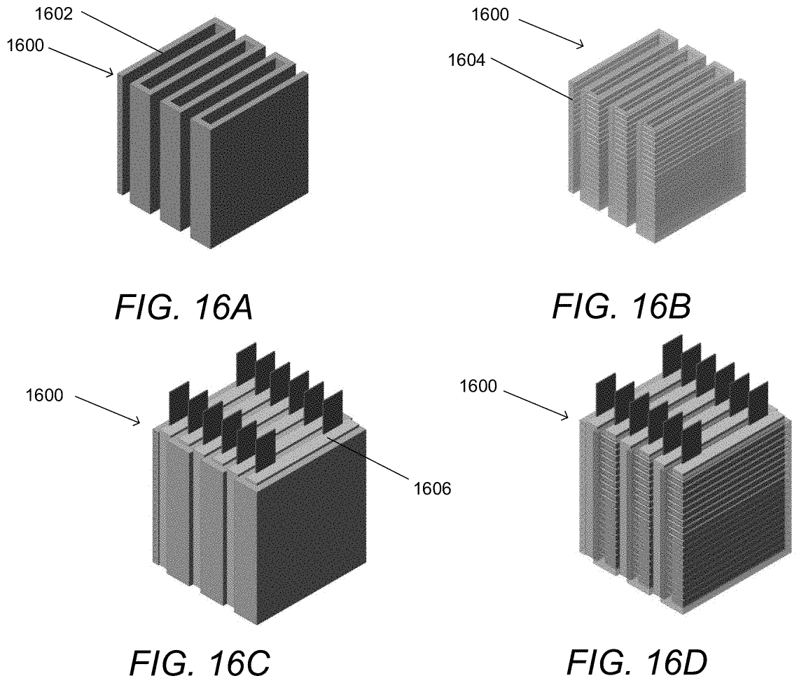

An example AM OHP battery case for prismatic and/or pouch cells is conceptually illustrated in FIGS. 16A-D. A prismatic cell battery case 1600 can include walls 1602. The walls 1602 can be all contiguous with each other. An OHP 1604 can be integrated within the walls 1602. In various embodiments, an OHP can be incorporated into walls of a battery case during manufacture (e.g., using an additive manufacturing process). The OHP can be a three-dimensional OHP, in various embodiments. FIG. 16A depicts a battery case heat transfer device. FIG. 16B shows a battery case heat transfer device with transparence to show the internal structure (e.g., the OHP 1604) of the battery case walls 1602. FIG. 16C shows the case 1600 loaded with cells 1606. FIG. 16D shows the case 1600 in transparence such that the OHP 1604 is visible.

In several examples above, a proposed system can refer to a AM OHP LIB designed around a cylindrical cell (e.g., around the popular 18650 cell format), the conceptual design described here is extensible to other cell formats as well. For instance a similar design could be configured for prismatic cells. Indeed, the proposed case offers capabilities that remain desirable for many high-performance batteries, as the ability to efficiently draw heat away from the cells and maintain isothermality can be important for any practical battery system operating at its performance limits where even small thermodynamic inefficiencies lead to significant levels of heat generation. The various specific examples above discuss using OHP systems for AM OHP LIB cases. Still, the specific discussion above applies to OHP enabled heat transfer systems. Various embodiments of OHP enabled heat transfer systems are discussed in the next section.

While specific processes and/or systems for an AM LIB case with an embedded OHP are described above, any of a variety of processes and/or systems can be utilized as an AM LIB case with an embedded OHP as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference an AM LIB case with an embedded OHP, the techniques disclosed herein may be used in any type of thermal management system. The techniques disclosed herein may be used within any of the thermal management system, heat transfer devices, battery cases and/or other devices and/or systems as described herein.

### Configuration of OHP Enabled Heat Transfer Systems

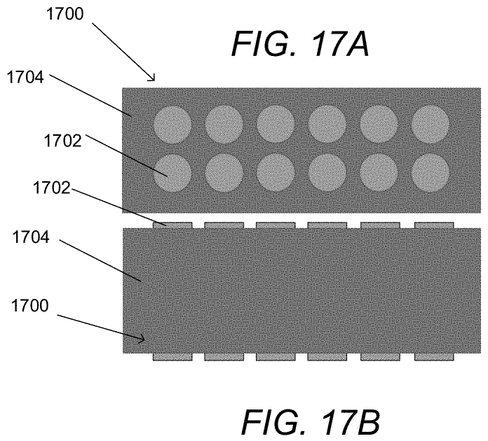

In accordance with various embodiments of the invention, OHP enabled heat transfer systems can have many configurations. An OHP Enabled heat transfer system can be used for process fluids, battery managements, and/or other heat transfer applications. Two views of a first configuration of an OHP enabled heat transfer system are conceptually illustrated in FIGS. 17A-B. A case 1700 can have thermal elements 1702 arranged within the case. The case 1700 can incorporate an OHP. The case can be monolithic. The case 1700 can include a single body section 1704. The integrated OHP can be a single OHP in some embodiments. In various embodiments, an integrated OHP can be at least 2 separate OHP systems.

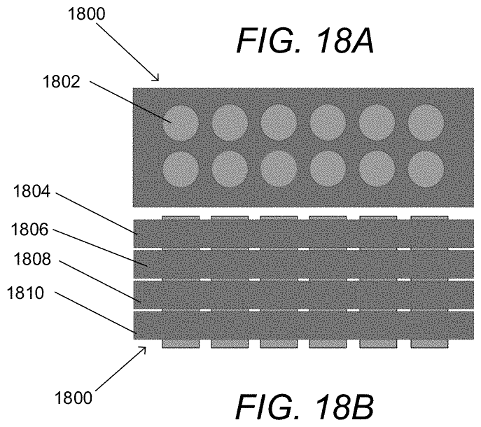

Two views of a second configuration of an OHP enabled heat transfer system are conceptually illustrated in FIGS. 18A-B. A case 1800 can have thermal elements 1802 arranged within the case. The case 1800 can incorporate an OHP. The case can be divided. In several embodiments, cases incorporate at least two body sections. The case 1800 can include a first body element 1804, a second body element 1806, a third body element 1808, and a fourth body element 1810. One or more of the body elements (e.g., all of the body elements) can have integrated OHP. In some embodiments, for a number of body elements, each body element can have an OHP, the OHPs can be separate, and/or the OHPs can be charged to different fill fractions. In some embodiments, each of the OHPs can have an optimal performance under different thermal conditions. For instance, in some embodiments, a first OHP in a first body element could be configured to have maximum performance at a first thermal condition, and a second OHP in a second body element could be configured to have a maximum performance at a second thermal condition. In several embodiments, multiple, different configured OHPs can be integrated into a single body element. Each thermal element 1802 is in contact with all the body elements 1804, 1806, 1808, and 1810.

In many embodiments of the invention, multiple OHPs can be incorporated into an OHP thermal system. A first OHP can have a first maximum performance at a first thermal condition. A second OHP can have a second maximum performance at a second thermal condition. In many embodiments the first thermal condition can correspond to normal performance (e.g., of a LIB), and/or the second thermal condition can correspond to an abnormal thermal condition (e.g., thermal condition associated with thermal runaway in a LIB).

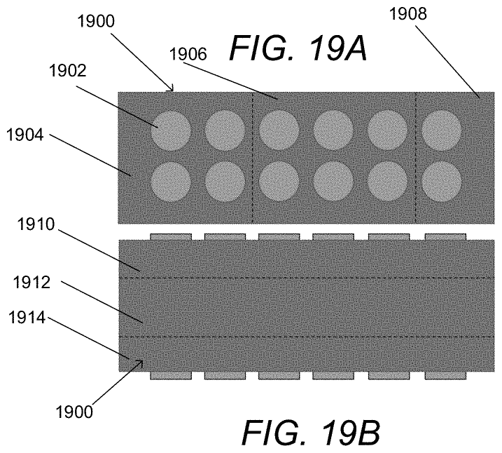

Two views of a third configuration of an OHP enabled heat transfer system are conceptually illustrated in FIGS. 19A-B. A case 1900 can have thermal elements 1902 arranged within the case. The case 1900 can incorporate a number of OHP. The case 1900 can be monolithic with the OHPs divided into regions. In some embodiments, the regions can be different sizes. The regions can correspond to OHPs configured with different thermal parameters (e.g., performance curves with respect to thermal performance). The case 1900 has a first region 1904, second region 1906, third region 1908, fourth region 1910, fifth region 1912, sixth region 1914. In some embodiment the regions can overlap, the regions overlapping can correspond to OHPs overlapping.

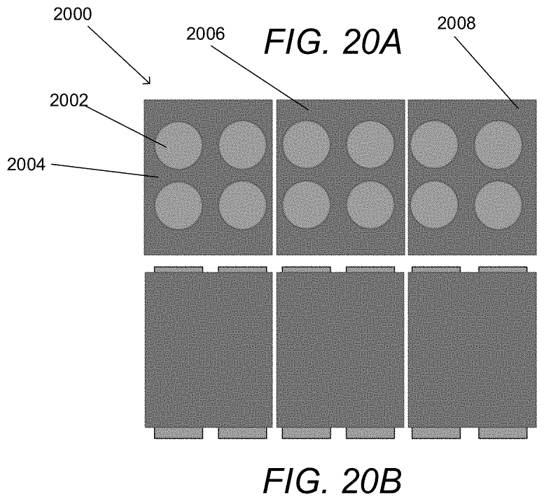

Two views of a fourth configuration of an OHP enabled heat transfer system are conceptually illustrated in FIGS. 20A-B. A case 2000 can have thermal elements 2002 arranged within the case. The case 2000 can incorporate an OHP. The case can be divided. In several embodiments, cases incorporate at least two body elements. The case 2000 can include a first body element 2004, a second body element 2006, and a third body element 2008. One or more of the body elements (e.g., all of the body elements) can have integrated OHP. In some embodiments, for a number of body elements, each body element can have an OHP, the OHPs can be separate, and/or the OHPs can be configured with different thermal parameters. Each thermal element 2002 is in contact with only one of the body elements 2004, 2006, or 2008.

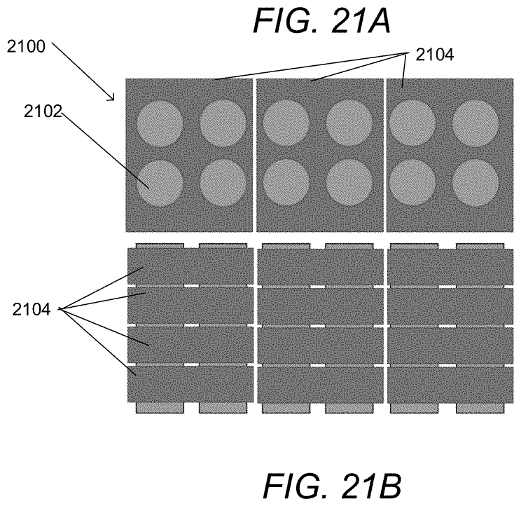

Two views of a fifth configuration of an OHP enabled heat transfer system are conceptually illustrated in FIGS. 21A-B. A case 2100 can have thermal elements 2102 arranged within the case. The case 2100 can incorporate an OHP. The case can be divided along two or more perpendicular planes. In some embodiments, a case can be divided along any surface. The case 2100 can include 12 body elements 2104. In several embodiments, a case could have any number of body elements.

In accordance with various embodiments of the invention, OHP enabled hear transfer systems include heatsinks. Various configuration of heatsinks can be used. In some embodiments, heatsinks can be in thermal communication with cold reservoirs and/or hot reservoirs. Heatsinks can include 1-phase pumped fluid loops (e.g., traditional serpentine, micro-channels, topology optimized, gyroid, lattice, and/or others), fines for direct external cooling, separate 2-phase systems (e.g., vapor chamber, heat pipes, loop heat pipe and/or others) and/or others. Various configurations for positioning a heatsink on an OHP enabled heat transfer system are discussed below, it is understood that these configurations could be combined with the various configurations discussed above.

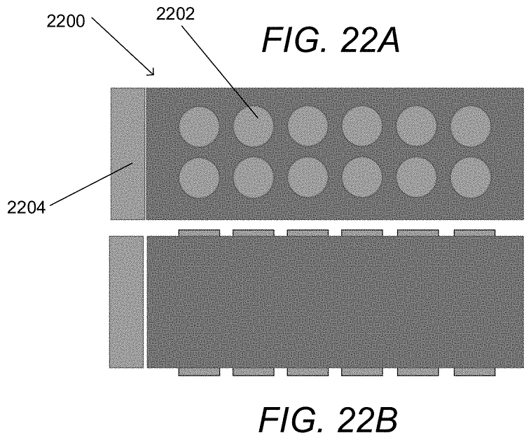

Two views of a first configuration for an OHP enabled heat transfer system with heatsinks included are conceptually illustrated in FIGS. 22A-B. A case 2200 can have thermal elements 2202 arranged within the case. A heatsink 2204 can be coupled to one side of the case 2200. In some embodiments the heatsink and the case can be manufactured as a single part.

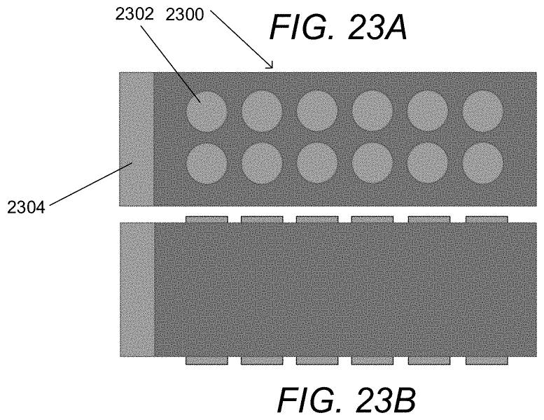

Two views of a second configuration for an OHP enabled heat transfer system with heatsinks included in FIGS. 23A-B are conceptually illustrated. A case 2300 can have thermal elements 2302 arranged within the case 2300. A heatsink 2304 can form a single piece with the case 2300.

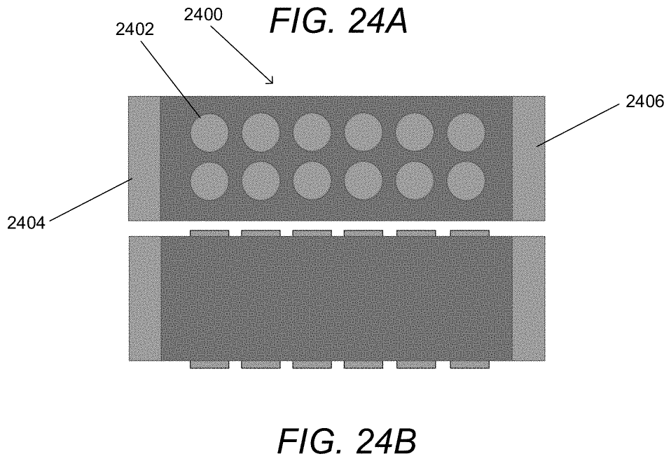

Two views of a third configuration for an OHP enabled heat transfer system with heatsinks included are conceptually illustrated in FIGS. 24A-B. A case 2400 can have thermal elements 2402 arranged within the case 2400. A first heatsink 2404 can be coupled to a first side of the case 2400. A second heatsink 2406 can be coupled to a second side of the case 2400. The first side opposite the second side. In some embodiments the first heatsink, the second heatsink and/or the case can be manufactured as a single part.

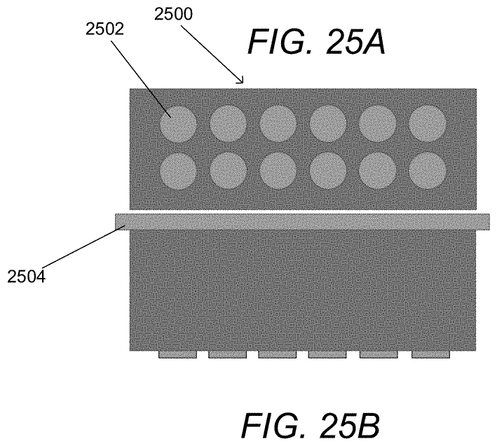

Two views of a fourth configuration for an OHP enabled heat transfer system with heatsinks included are conceptually illustrated in FIGS. 25A-B. A case 2500 can have thermal elements 2502 arranged within the case 2500. A heatsink 2504 can be coupled to a first side of the case 2500. The first side can correspond to a side of the case 2500 such that the heatsink 2504 intersects with a longitudinal axis of each thermal element 2502.

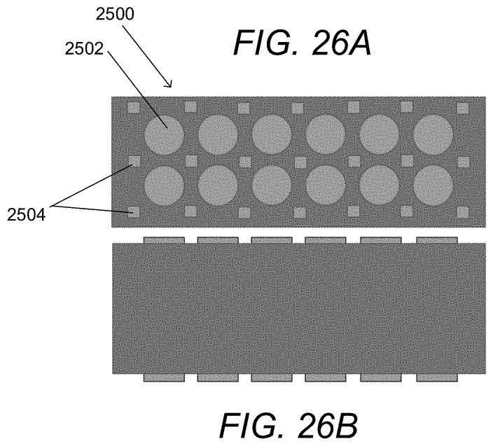

Two views of a fifth configuration for an OHP enabled heat transfer system with heatsinks included are conceptually illustrated in FIGS. 26A-B. A case 2600 can have thermal elements 2602 arranged within the case 2600. The case 2600 can have heatsink elements 2604 disposed along the case 2600. The heatsink elements 2604 can generally run parallel with the thermal elements. The heatsink elements 2604 can be manufactured as a single piece along with the case 2600.

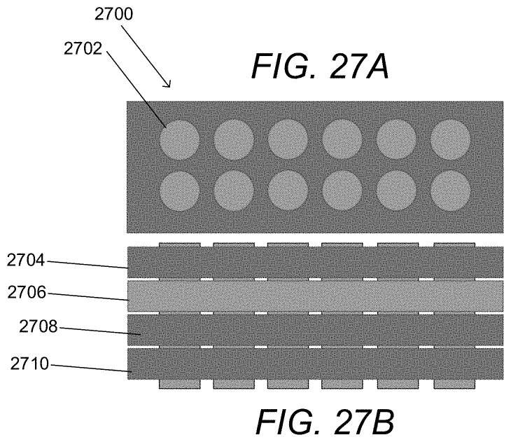

Two views of a sixth configuration for an OHP enabled heat transfer system with heatsinks included are conceptually illustrated in FIGS. 27A-B. A case 2700 can have thermal elements 2702 arranged within the case. The case 2700 can incorporate an OHP. The case can be divided. The case 2700 can include a first body element 2704, a second body element 2706, a third body element 2708, and a fourth body element 1710. One or more of the body elements (e.g., all of the body elements) can have integrated OHP. The second body element 2706 can be a heatsink.

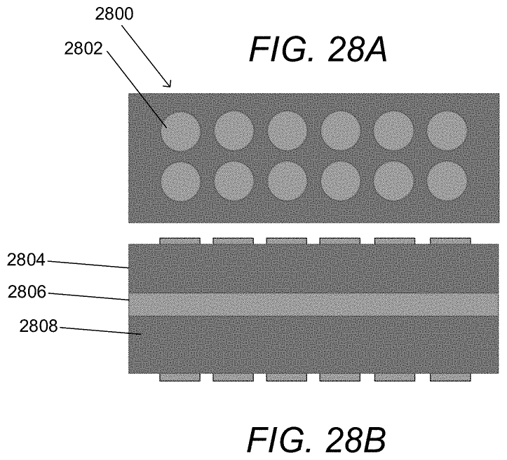

Two views of a seventh configuration for an OHP enabled heat transfer system with heatsinks included are conceptually illustrated in FIGS. 28A-B. A case 2800 can have thermal elements 2802 arranged within the case. The case 2800 can incorporate at least one OHP. The case can be monolithic. The case 2800 can include a first body element 2804 that incorporates an OHP, a second body element 2806 that is a heatsink, and a third body element 2808 that incorporates an OHP. The first, second and third body elements can be manufactured as a single part.

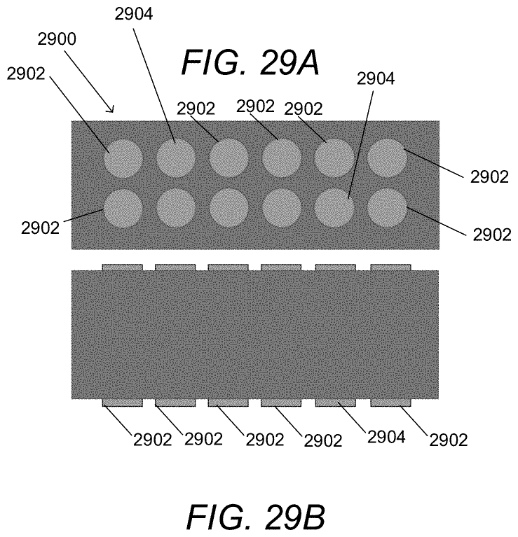

Two views of an eighth configuration for an OHP enabled heat transfer system with heatsinks included are conceptually illustrated in FIGS. 29A-B. A case 2900 can have thermal elements 2902 arranged within the case 2900. Some of the cell receivers in the case 2900 can be substituted for heatsink elements 2904. Heatsink elements, in various embodiments can be configured to be incorporated into cases by conforming to the shape of a cell.

While specific processes and/or systems for an OHP enabled heat transfer system are described above, any of a variety of processes and/or systems can be utilized as an OHP enabled heat transfer system as appropriate to the requirements of specific applications. In certain embodiments, steps and/or components may be performed and/or configured in any order, sequence, and/or configuration not limited to the order, sequence and/or configuration shown and described. In a number of embodiments, some of the above steps may be executed or performed substantially simultaneously where appropriate or in parallel to reduce latency and processing times. In some embodiments, one or more of the above steps and/or components can be rearranged or omitted. Although the above embodiments of the invention are described in reference an OHP enabled heat transfer system, the techniques disclosed herein may be used in any type of thermal management system. The techniques disclosed herein may be used within any of the thermal management system, heat transfer devices, battery cases and/or other devices and/or systems as described herein.

While the above description contains many specific embodiments of the invention, these should not be construed as limitations on the scope of the invention, but rather as an example of one embodiment thereof. Accordingly, the scope of the invention should be determined not by the embodiments illustrated, but by the appended claims and their equivalents.

What is claimed is:

1. A heat transfer device, the heat transfer device comprising:
a case configured to receive at least one thermal element, wherein the case comprises:
an integrated oscillating heat pipe, wherein the integrated oscillating heat pipe is integrated into at least one wall of the case, and wherein the integrated oscillating heat pipe comprises at least two or more layers; and
a heatsink element, wherein the heatsink element is in contact with at least one wall of the case,.

2. The heat transfer device of claim 1, wherein at least two thermal elements are spaced apart by the at least one wall.

3. The heat transfer device of claim 1, wherein at least two thermal elements are spaced apart by the at least one wall, and the wall is around 3 mm thick.

4. The heat transfer device of claim 1, wherein the at least one thermal element is a lithium ion cell.

5. The heat transfer device of claim 1, wherein the heat transfer device is manufactured as a single part using an additive manufacturing process.

6. The heat transfer device of claim 1, wherein at least one received thermal element is a heatsink.

7. The heat transfer device of claim 1, wherein the at least one wall includes various voids such that the weight of the heat transfer device is less than otherwise.

8. The heat transfer device of claim 1, wherein the integrated oscillating heat pipe comprises at least two or more layers that are in fluid communication.

9. The heat transfer device of claim 1, wherein the integrated oscillating heat pipe comprises at least two or more layers, and wherein the topology of adjacent layers are generally rotated 90 degrees from each other.

10. The heat transfer device of claim 1, wherein the case comprises a first integrated oscillating heat pipe and a second oscillating heat pipe.

11. The heat transfer device of claim 1, wherein the case comprises a first integrated oscillating heat pipe configured for maximum performance under a first set of thermal conditions and a second oscillating heat pipe configured for maximum performance under a second set of thermal conditions.

12. The heat transfer device of claim 1, wherein the case comprises a first integrated oscillating heat pipe with a first fill ratio corresponding to a first maximum performance under a first set of thermal conditions and a second oscillating heat pipe with a second fill ratio corresponding to a second maximum performance under a second set of thermal conditions.

13. The heat transfer device of claim 1, wherein the case further comprises a first portion with a first integrated oscillating heat pipe, and a second portion with a second integrated oscillating heat pipe, and wherein the first portion and the second portion are both in contact with both of at least two thermal elements received by the case.

14. The heat transfer device of claim 1, wherein the case further comprises a second integrated oscillating heat pipe, and wherein the first oscillating heat pipe is integrated in a first region of the at least one wall, and wherein the second oscillating heat pipe is integrated in a second region of the at least one wall.

15. The heat transfer device of claim 1, wherein the case further comprises a first portion with a first integrated oscillating heat pipe, and a second portion with a second integrated oscillating heat pipe, and wherein each thermal element of the at least one thermal element is in contact with at most integrated oscillating heat pipe selected from among the first and the second integrated oscillating heat pipe.

16. The heat transfer device of claim 1, wherein the case if further configured to receive that at least one thermal element into a receiver, and wherein the receiver is further configured to receive a heatsink element.

17. The heat transfer device of claim 1, wherein the case comprises a first integrated oscillating heat pipe tunable to a first thermal setting and a second oscillating heat pipe tunable to a second set of thermal conditions, the second set of thermal conditions.

18. The heat transfer device of claim 1, wherein the case comprises a first integrated oscillating heat pipe with a first fill ratio, a second oscillating heat pipe with a second fill ratio, the second fill ratio different from the first fill ratio.

19. The heat transfer device of claim 1, wherein the case comprises a first integrated oscillating heat pipe with a first working fluid, and a second oscillating heat pipe with a second working fluid, the second working fluid different from the first working fluid.

20. The heat transfer device of claim 1, wherein the case if further configured to receive that at least one thermal element into a receiver, and wherein the receiver is further configured to receive a heatsink element.
